(19) United States
(12) Patent Application Publication
(10) Pub. No.: US 2008/0004958 A1
(43) Pub. Date: Jan. 3, 2008

(54) Client side counting verification testing

(76) Inventors: Tony Ralph, Sunnyvale, CA (US); Ilya Slain, Santa Clara, CA (US); Victor Chang, Sunnyvale, CA (US); Brian France, Indianapolis, IN (US)

Correspondence Address: BRINKS HOFER GILSON & LIONE / YAHOO! OVERTURE, P.O. BOX 10395, CHICAGO, IL, 60610, US

(21) Appl. No.: 11/478,331

(22) Filed: Jun. 29, 2006

(51) Int. Cl. G06Q 30/00

(52) U.S. Cl. 705/14

(57) ABSTRACT

A system and method are disclosed for measuring online advertising. A system for verifying the accuracy of measured ad impressions is utilized by comparing traditional web access logs. Specifically, comparisons of ad impression counts are made of the Client Side Counting (“CSC”) advertisement infrastructure with the traditional access log counting.

### TECHNICAL FIELD

The present embodiments relate generally to the display of advertisements on various pages or screens, such as websites. Specifically, the verification of advertisement monitoring or impressions is disclosed.

### BACKGROUND

Online advertising may be an important source of revenue for enterprises engaged in electronic commerce. A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. An advertisement can be selected for display each time the page is requested, for example, by a browser or server application.

Online advertisers want to know how many impressions that any given online advertisement receives from consumers. An ad impression may be defined as the number of times an ad is rendered for viewing. For example, one impression may be equivalent to one opportunity to see an ad. Web sites and ad serving companies need an accurate count of the number of ad impressions because ad impressions may be used to determine the pay rate for an ad. An impression may simply be the number of times an ad is displayed.

Traditional media, such as television, utilizes a ratings system (such as that provided by Nielsen Media Research) to estimate the number of viewers for a particular show and the advertisements for that show. No such system exists for the Internet. In order for an advertiser to agree to pay for a particular advertisement, that advertiser would like to know with reasonable certainty, the number of people or impressions that ad will receive. However, online advertisements are susceptible to robots, spiders, or other monitoring mechanisms, which may artificially inflate the number of impressions. A robot or spider may be used to index a particular website, but no advertisement is viewed by a person in this indexing. Accordingly, advertisers on the Internet want an accurate count of the number of impressions that an ad receives that exclude robots, spiders or other non-human activity.

Many websites may utilize web server logs to measure the number of ad impressions. The web server logs include the number of times that a particular website is accessed. Accordingly, an advertiser may be charged for each access to the website. However, this method may not filter out the non-human activity as discussed above. There is a movement in the industry to account for ad impressions via some type of action initiated by the end user's browser to allow for more accurate results. These results may be more accurate because they help to eliminate robotic activity and account for network latency.

### SUMMARY

By way of introduction, the embodiments described below include a method and system for measuring online advertising. The embodiments relate to a system and method for verifying the accuracy of measured ad impressions.

In a first aspect, a method for verifying advertisement impressions in a page is disclosed. A page includes at least one advertisement and at least one beacon. The logging data regarding the at least one beacon is recorded. The beacon is configured to determine the advertisement impressions. The advertisement impressions are then verified in the page.

In a second aspect, a computer readable storage medium is disclosed having stored therein data representing instructions executable by a programmed processor for confirming advertisement impressions. The storage medium includes instructions for measuring advertisement impressions with an identifier. In addition, an identifier logging data regarding the measured advertisement impressions is recorded, and a web server logging data regarding advertisement delivery is recorded. The identifier, the identifier logging data, the web server logging data, or combinations thereof are compared to confirm the measured advertisement impressions.

In a third aspect, a system includes a network, a web server, an ad server and a beacon server coupled with the network. The beacon server is configured to include an identifier with an advertisement. The identifier tracks the ad impressions. The ad server is configured to verify the ad impressions tracked by from the identifier.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims and be defined by the following claims. Nothing in this section should be taken as a limitation on those claims. Further aspects and advantages are discussed below in conjunction with the preferred embodiments.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

FIG. 1 provides a simplified view of one embodiment of an operating environment;

FIG. 2 is a block diagram of an exemplary network;

FIG. 3 is a block diagram of an embodiment of ad elements;

FIG. 4 is a flowchart illustrating an embodiment for comparing the logging of advertisements;

FIG. 5 is a flowchart illustrating an alternate embodiment for comparisons; and

FIG. 6 is block diagram of a computing system.

### DETAILED DESCRIPTION

Advertisers and advertising providers would like an accurate measure of ad impressions to determine the value of a particular advertisement or ad location. The International Advertising Bureau (“IAB”) has established that an ad impression should be a measurement of responses from an ad delivery system to an ad request from the user's browser, which is filtered from robotic activity and is recorded at a point as late as possible in the process of delivery of the creative material to the user's browser—therefore closest to actual opportunity to see by the user. Two methods may be used to deliver ad content to the user—server-initiated and client-initiated. Server initiated ad counting uses the site's web content server for making requests, formatting and re-directing content. Client-initiated ad counting relies on the user's browser to perform these activities. Client Side Counting (“CSC”) is an industry-sponsored standard utilizing a client-initiated approach.

Client Side Counting (“CSC”) is an industry-sponsored standard proposed through the Interactive Advertising Bureau (“IAB”). By adopting this standard, ad serving companies could employ consistent techniques when measuring ad impressions across different technologies and platforms. According to LAB, adoption of the CSC standard will result in two benefits to advertisers and the industry: It will lower discrepancy rates of media places across multiple systems, and it will improve the quality and consistency of the collected data. CSC will be described in more detail below regarding

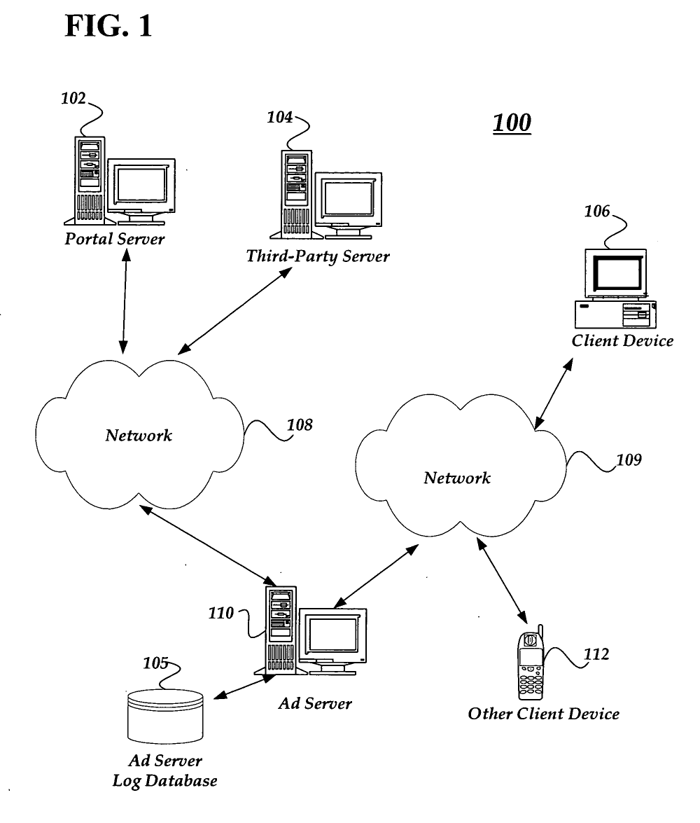

FIG. 1 provides a simplified view of a network environment 100. Not all of the depicted components may be required, however, and some embodiments of the invention may include additional components not shown in the figure. Variations in the arrangement and type of the components may be made without departing from the spirit or scope of the claims as set forth herein. Additional, different or fewer components may be provided.

In FIG. 1, environment 100 includes an ad server 110, which may provide a platform for selection, optimization, and/or distribution of advertisements for inclusion in any pages over a network, such as web pages over the Internet. Logs or records of displayed ads are stored in the ad server log database 105. Advertisements on the pages may be provided to clients by a portal server 102 and/or a third-party server 104. In FIG. 1, clients are represented by a client device 106, depicted as a conventional personal computer, and/or other device such as a mobile client device 112, including a network-enabled mobile phone, personal digital assistant (PDA), pager, network-enabled television, digital video recorder, such as TIVO®, and/or automobile. The client(s) are an example of users that will be viewing advertisements.

Some or all of ad server 110, portal server 102, and third-party server 104 may be in communication with each other by way of network 108. The ad server 110 and portal server 102 may each represent multiple linked computing devices, and multiple third-party servers, such as third-party server 104, may be included in environment 100. Network 108 may be regarded as a public or private network connection and may include, for example, a virtual private network or an encryption or other security mechanism employed over the public Internet, or the like.

Client device 106 and mobile client device 112 are represented by user-interactive devices that typically run browser applications, and the like, to display requested pages received over a network that include advertisements. The user/client may be a consumer of goods of services that is searching for a business such as a business of the advertiser. Such devices are in communication with portal server 102 and/or third-party server 104 by way of network 109. Network 109 may include the Internet and may include all or part of network 108; network 108 may include all or part of network 109.

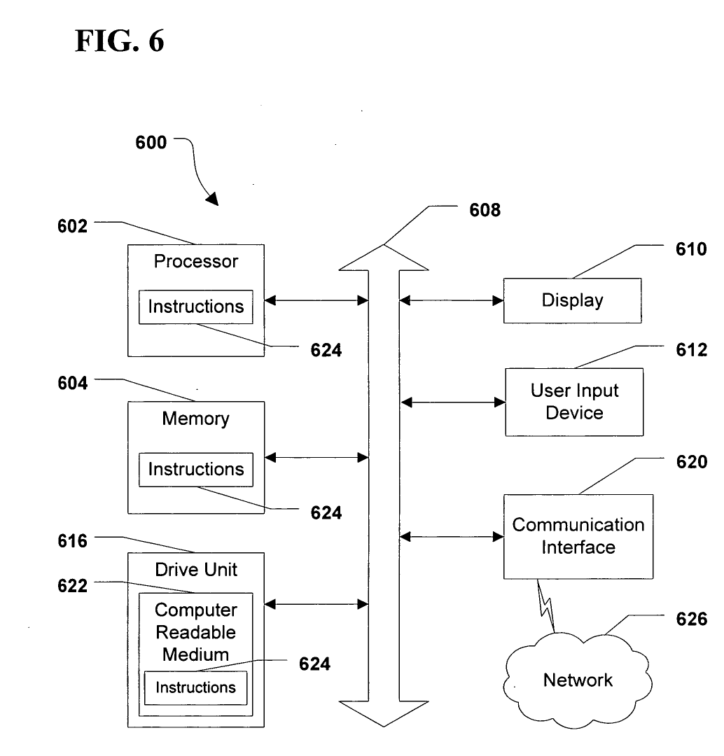

Portal server 104, third-party server 104, ad server 110, log database 105, client device 106, and mobile client device 112 represent computing devices of various kinds as discussed below with FIG. 6. Such computing devices may generally include any device that is configured to perform computation and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, client device 106 may be configured to execute a browser application that employs HTTP to request information, such as a web page, from a web server, which may be a process executing on portal server 102 or third-party server 104.

Networks 108, 109 may be configured to couple one computing device to another computing device to enable communication of data between the devices. Networks 108, 109 may generally be enabled to employ any form of machine-readable media for communicating information from one device to another. Each of networks 108, 109 may include one or more of a wireless network, a wired network, a local area network (LAN), a wide area network (WAN), a direct connection such as through a Universal Serial Bus (USB) port, and the like, and may include the set of interconnected networks that make up the Internet. Networks 108, 109 may include any communication method by which information may travel between computing devices.

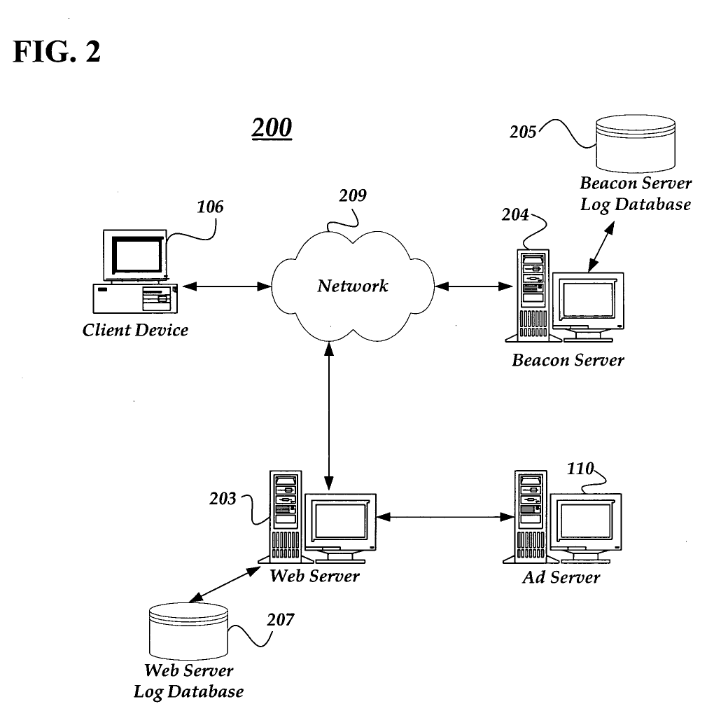

The ad server 110 may be used for providing advertisements that are displayed to clients 106. The ads that are displayed or transmitted to the client 106 may be recorded in the log database 105. The ad server log database 105 may be used for traditional access log ad impression counting. In one embodiment, the ad server log database may only record a subset of the information transmitted over networks 108 and/or 109. The data that is stored in the log database 105 may be dependent on the type of ad counting mechanism that is used. Before CSC, traditional access logs may have included data or information similar to that stored by CSC logs. Although not shown in FIG. 1, the ad server 110 may not talk with the client 106 and include an intermediary, such as the web server 203 in FIG. 2.

Both the web server in the traditional server log style counting and the beacon servers may have a web server software. One example of which is APACHE, an open source web server software application. The general format of the logs involved in either traditional or CSC may be the same or may be different. Both the traditional logs and the CSC logs may contain similar non-ad information like the referrer, the URL requested, date/time, cookie information, etc. They may also include a field with ad-specific information. Both the traditional and CSC beacon server logs may contain similar ad information, such as the location on the page and specific tracking information related to that ad. The delimiters may be different, and there may be some more granular tracking metrics for CSC logs. The generation of the log entry is different for CSC because it is initiated by a beacon on the client.

FIG. 2 is a block diagram of an alternate network environment 200. Environment 200 may be one embodiment for utilizing Client Side Counting (“CSC”). Environment 200 includes a client device 106 as discussed above connected over a network 209 to a web server 203 with a web server log database 207 and a beacon server 204 with a beacon server log database 205. The web server may be coupled with the ad server 110 as discussed above.

The web server 203 may be a portal allowing the client 106 to access a network, such as the Internet. The client 106 may request content from the web server 203. The web server 203 provides the content, only after receiving advertising content from the ad server 110. In a CSC context, the content may include a beacon that is added to the content that the web server 203 delivers to the client 106. The web server 203 may include a web server log database 207 that is used to track the requests for pages or the delivery of pages. In a non-CSC advertising system the web server log database may store information on web pages that are requested or delivered. Accordingly, these web server logs may be used to charge an advertiser based on delivery of an advertisement. The web server log database 207 may be referred to as “web server access logs” and may record the ads shown on web pages. The logs may record which files (URL's, pages, etc.) the web server has delivered and inside each access log entry may be information on the ads included in that outbound page. Accordingly, the ads that are displayed or transmitted to the client 106 may be recorded in the web server access logs of the host, which served the page containing the ads.

Stored logs may contain one line for every page/file served by the webserver. Along with information on the date/time of the request, the URL requested, the referrer (from where the request was made), etc. ad-specific information may be logged which operates to maintain a record the ads shown on the page. As discussed below, logs may only be recorded once the client has created the final CSC beacon URL in the browser on the client side and the browser then requests this URL.]

A beacon is an identifier that is inserted into a web page to track viewing of elements within that page. The beacon may be a uniquely identifiable 1×1 pixel that is placed in a web page after an ad is inserted into that page. In one embodiment, a beacon may be JavaScript that is inserted into a page. The JavaScript may be associated with each advertisement on the page. There also may be a final JavaScript at the end of the page. The JavaScript may be referred to as beaconing code. Also, the beacon, such as a 1×1 pixel or image, may be a uniform resource locator (“URL”) that includes ad information for a page.

After the page containing the ad is delivered by the web server 203 to the client 106, the beacon server 204 (also referred to as a pixel counter) may request the beacon in order to count the ad impression viewed by the client 106. In particular, the URL which is formed may be requested by the browser. The URL actually requests (and returns) a dummy 1×1 empty image. Accordingly, the logging of the beacon information may be a request for a (dummy) file. The request may result in logged information related to the ads on the page where the URL was formed.

The beacon may submit a request to the beacon server 204 upon being loaded onto a page. Specifically, the final JavaScript in the page may send a request to the beacon server 204 including the advertisement information from that page. The beacon server 204 may then record information received from beacons in the beacon server log database 205. The beacon request to the beacon server 204 may be used as a way of counting an ad impression that is triggered upon the ad being viewed. In one embodiment, the beacon server 204 may be a part of or coupled with the ad server 110. Likewise, the beacon server 204 may be a part of or coupled with the web server 203. The beacon server 204 counts the fetching and delivery of a beacon as an ad impression. The ad impressions may be recorded and stored in the beacon server log database 205. The log data stored in the beacon server log database 205 may be raw data that is cleansed or edited.

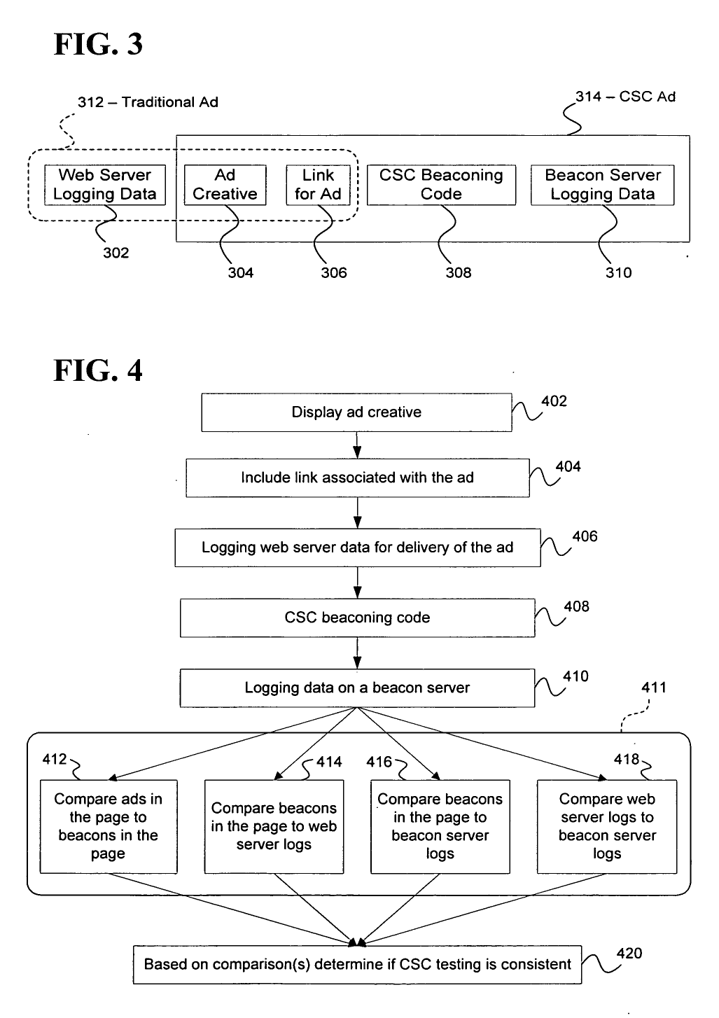

FIG. 3 illustrates the components or elements of a traditional advertisement and a client side counting advertisement. Specifically, a traditional ad 312 may include web server logging data 302, an ad creative 304, and a link for the ad 306. The CSC ad 314 may include the ad creative 304, the link for the ad 306, the CSC beaconing code 308 and the beacon server logging data 310.

The web server logging data 302 is used for a traditional ad 312, but not a CSC ad 314. As discussed above in association with FIG. 2, the web server log database 207 may store information on web pages that are requested or delivered. The ad creative 304 may be the advertisement itself as seen by the consumer. For example, on a web page, the ad creative 304 may be an image advertising a product or service, such as a JPG or GIF file. Alternatively, the ad creative 304 may be textual in nature and describe a product or service. Finally, the traditional ad 312 may include a link for the ad 306. The link 306 associated with the ad may record information specific to the ad. The link 306 may include a link to the advertiser's web site or additional information regarding the advertised company, product, or service. Upon clicking on the link 306, the may record information specific to the ad. For example, upon clicking on the ad, web server logging data 302 may be recorded identifying that there was a successful conversion or impression for that particular ad. The number of conversions may be used to charge the advertiser.

The CSC ad 314 includes the ad creative 304, and the link for the ad 306 in addition to CSC beaconing code 308 and beacon server logging data 310. As discussed above, the CSC beaconing code 308 may be used to identify when a page has been viewed. The CSC beaconing code 308 may be referred to as a beacon, which is an identifier that is inserted into a web page to track viewing of elements within that page. As discussed above, the CSC beaconing code may be JavaScript that is inserted into a page and associated with each advertisement on the page. The beacon server logging data 310 records the information from the beacon or CSC beaconing code 308. Specifically, the beacon server logging data 310 may record the number of viewings of a page or elements on a page. The beacon server logging data 310 may then be used to charge the advertisers for advertisements based on the number of times that the ad is viewed.

FIG. 4 is a flow chart illustrating the verification of CSC. As discussed above, CSC may be used to determine the number of times that an ad is viewed. The web server logs may be used to measure the number of times that an ad is requested from a web server or delivered to the user. Accordingly, FIG. 4 illustrates one procedure in which a verification or test is used to determine how the CSC measurements compare with the web server measurements. In step 402, an ad is displayed. As discussed above, the ad creative 304 is displayed in a page, such as a web page. In step 404, a link is associated with the ad. As discussed above, the link for the ad 306 may be used to record user interaction with the ad or page. In step 406, a web server logs web server data for delivery of the ad. Specifically, a web server may measure the requests or transmissions of a page with a particular ad displayed in that page. In step 408, CSC beaconing code is included in the ad or page to monitor whether a page or ad is viewed. In step 410, the data from the beaconing code is logged onto a beacon server.

Steps 402-410 incorporate elements discussed in FIG. 3 for both the web server ad 312 measurement and the CSC ad 314 measurement. Accordingly, in steps 412-418, a comparison may be made to verify the CSC beaconing code is accurately and correctly recording the number of user viewings of a page. In particular in step 420, the comparisons in steps 412-418 may verify if the CSC testing or measurements are consistent.

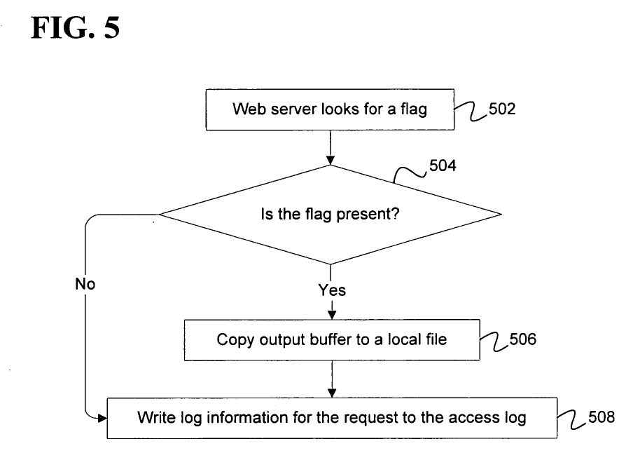

In step 412, the ads in a page are compared with the beacons in the page. The beacon information in the page should mirror the ad information in the page which existed prior to CSC. Each ad in the page, has specific data relating to it's position in the page, tracking information etc. To determine if the beacon information is properly recorded, a comparison may be made between the location, tracking information and content of the ads with the information that the beacon may include. The comparison may track the accuracy of the beacon data by comparing the beacon data with the actual ads. In this scenario, the beacon data should mirror the ad data with 100% accuracy since the information is available in the same data store on the adserver. The measurement of the ads in a page or the beacons in a page may be accomplished by monitoring a transient outgoing page as discussed in FIG. 5. As discussed below, FIG. 5 illustrates one embodiment of a method for monitoring or snooping the transmitted web pages, which may allow for real-time monitoring.

In step 414, the beacons in a page are compared with the web server logs. As discussed above, the beacons in a page may include ad information. This information may be compared with the web server logs. The beacons may include information on the number, content and location of ads. The web server logs may include the same information regarding the ads that are displayed on a page. As in the comparison from step 414, the beacon information may be compared to determine its accuracy. In one embodiment, the web server logs may include the pages that are transmitted and include ad information that is used to determine the accuracy of the beacon information. Accordingly, a comparison between the beacons and the web server logs may be used to verify that the beacon data is accurate.

In step 416, the beacons in the page are compared with the beacon server logs. The beacon server logs may record information retrieved from the individual beacons in a page. As discussed above, the beacon server logs may include the number of times that a beacon and the corresponding ads are displayed. This comparison may ensure the beacon information is consistent between the beacon(s) on the page and those recorded in the beacon logs. For example, with CSC a new identifier may be introduced that is referred to as a “pageview id.” This pageview id is not recorded in the ad data or in the web log data. To ensure the pageview ids were being recorded correctly the place the data exists is in the beacons in the page and in the beacon server access logs. Accordingly, a comparision between beacon server logs and the beacons may allow verification of the pageview id, which may be used in CSC log processing.

In step 418, the web server logs are compared with the beacon server logs. The web server logs may include the number of times that any given page is requested and transmitted by the web server. The beacon server logs may include the number of times that a beacon reports being viewed by a user. The beacon server logs may be compared with the web server logs to verify that the beacon server log data regarding the number of ads that are viewed is comparable with the number of pages that are requested or transmitted. In one embodiment, the number of times that an ad is requested/transmitted may be much greater than the number of times that an ad is viewed because non-human or robot requests may be included in the web server logs. Accordingly, the web server logs may have to be analyzed to filter out the robotic requests when making a comparison, or the comparison may include a consideration of the fact that the web server logs include non-human requests. The beacon server logs register the number of times that a page is viewed, so the non-human or robotic activity should not trigger the beacon and be recorded in the beacon server logs. In the context of verification testing in a quarantined environment there may be no robotic requests. Accordingly, rather than filtering out robotic traffic, an assumption of 100% matching may be made.

Step 418 may be used as a comparison of the accuracy of ad impression calculations. In particular, a comparison with the web server logs may determine if the beacon logs are properly tracking the ad impressions for a page or ad. The comparison may be a percent comparison. The comparison may take into account the robots discussed above. In one embodiment, it may be known that the ad impressions tracked by the beacon logs should be approximately 80% of the ad impressions tracked in the web server logs. The percentage of robots may be known to be 20% and the web server logs do not remove those hits from its logs of ad impressions. In alternate embodiments, the comparison between the web server logs and beacon logs may consider other measures to verify the accuracy of the beacon logs.

As discussed above, the testing the system may control the traffic behavior and help limit robotic activity. Thorough testing in this context may be undertaken to determine if CSC data and counts are identical to the former counts. An exact correlation between CSC logs and web logs may be required in a quarantined environment. When testing with live traffic, robotic data activity may occur and be measured for comparisons.

In alternate embodiments, the number of comparisons may vary. There may be more or fewer comparisons that are made. Accordingly, the steps 402-410 may be unnecessary for different comparisons. Alternatively, there may be more steps that are not shown for other comparisons. The comparisons may include determining if the ad impressions from CSC, through the use of beacons or a beacon server log database, are similar to the ad impressions that are derived through a web server.

FIG. 5 is a flowchart illustrating an alternate embodiment for comparisons. In particular, FIG. 5 presents one method for gathering the data for ads in a page and beacons in a page as discussed above. In step 502, the web server looks for a flag in any web traffic. The flag may be in the form of a file. The web server may utilize the flag to monitor or snoop on outgoing http traffic. The web server checks to see if the flag is present in act 504. If the flag is present, then the output buffer of the web server is copied to a local file in act 506. The data copied to a local file is a snapshot of what is sent to the user. Accordingly, that local file may be used to verify the ads in the page that are sent to the user. Then, the log information is written to the access log in step 508. If a flag is not present, then no local file is written.

The local file may be on a local file system or may be where the outgoing requests are recorded. The local file may be analyzed for the comparisons discussed above. In particular, the local file may assist in the comparisons from steps 412 and 414. The snooping may operate in real-time so that when a page is served, the local file is created that includes what is sent to the user. This allows for real-time checks of data. The web server may automatically check for a flag in a periodic intervals. In alternate embodiments, the process may be manual, requiring the web server to be told to check for a flag.

The web server may check for the existence of a flag or a file whenever a new child process is spawned. When a flag is found, the web server may write to the client socket like normal as well as writing the same data to an audit file. The corresponding log line may be written to the access log file and may also be written to the same audit file as the outbound request. Thus, when the flag is turned on, each web server child process may create a file which contains outgoing requests interleaved with the corresponding access log lines for those requests. The resultant audit files may then be parsed to examine the consistency of data within the page or to ensure the content in the page matches the content in the log line corresponding to the page.]

Referring to FIG. 6, an illustrative embodiment of a general computer system is shown and is designated 600. As discussed above, FIGS. 1-2 may include computing devices or computing systems of various kinds. Accordingly, the computer system 600 may be an embodiment of any of the components discussed above, including but not limited to the portal server 104, third-party server 102, ad server 110, log database 105, client device 106, mobile client device 112, beacon server 204, web server 203, beacon server database 205, web server log database 207, or combinations thereof. The computer system 600 may include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604 that can communicate via a bus 608. The memory 604 may be a main memory, a static memory, or a dynamic memory. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 604 includes a cache or random access memory for the processor 602. In alternative embodiments, the memory 604 is separate from the processor 602, such as a cache memory of a processor, the system memory, or other memory. The memory 604 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts or tasks illustrated in the figures or described herein may be performed by the programmed processor 602 executing the instructions stored in the memory 604. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 600 may further include a display unit 614, such as a liquid crystal display (LCD), an organic light emitting diode (OLED), a flat panel display, a solid state display, a cathode ray tube (CRT), a projector, a printer or other now known or later developed display device for outputting determined information. The display 614 may act as an interface for the user to see the functioning of the processor 602, or specifically as an interface with the software stored in the memory 604 or in the drive unit 606.

Additionally, the computer system 600 may include an input device 616 configured to allow a user to interact with any of the components of system 600. The input device 616 may be a number pad, a keyboard, or a cursor control device, such as a mouse, or a joystick, touch screen display, remote control or any other device operative to interact with the system 600.

In a particular embodiment, as depicted in FIG. 6, the computer system 600 may also include a disk or optical drive unit 606. The disk drive unit 606 may include a computer-readable medium 610 in which one or more sets of instructions 612, e.g. software, can be embedded. Further, the instructions 612 may embody one or more of the methods or logic as described herein. In a particular embodiment, the instructions 612 may reside completely, or at least partially, within the memory 604 and/or within the processor 602 during execution by the computer system 600. The memory 604 and the processor 602 also may include computer-readable media as discussed above.

The present disclosure contemplates a computer-readable medium that includes instructions 612 or receives and executes instructions 612 responsive to a propagated signal, so that a device connected to a network 620 can communicate voice, video, audio, images or any other data over the network 620. Further, the instructions 612 may be transmitted or received over the network 620 via a communication port 618. The communication port 618 may be a part of the processor 602 or may be a separate component. The communication port 618 may be created in software or may be a physical connection in hardware. The communication port 618 is configured to connect with a network 620, external media, the display 614, or any other components in system 600, or combinations thereof. The connection with the network 620 may be a physical connection, such as a wired Ethernet connection or may be established wirelessly as discussed below. Likewise, the additional connections with other components of the system 600 may be physical connections or may be established wirelessly.

The network 620 may include wired networks, wireless networks, or combinations thereof. The wireless network may be a cellular telephone network, an 802.11, 802.16, 802.20, or WiMax network. Further, the network 620 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A method for verifying advertisement impressions in a page, the method comprising:
including at least one advertisement in the page;
including at least one beacon within the page;
recording logging data regarding the at least one beacon, wherein the at least one beacon is configured to determine the advertisement impressions; and
verifying the advertisement impressions in the page.

2. The method according to claim 1 wherein the step of verifying includes comparing the at least one advertisement with the at least one beacon within the page.

3. The method according to claim 1 wherein the step of verifying includes comparing the at least one beacon within the page to the logging data regarding the at least one beacon.

4. The method according to claim 1 further comprising:
recording web server logs related to delivery of the at least one advertisement.

5. The method according to claim 4 wherein the step of verifying includes comparing the web server logs with the at least one beacon.

6. The method according to claim 4 wherein the step of verifying includes comparing the web server logs with the logging data.

7. The method according to claim 4 wherein the web server logs are copied to a local file if a flag is present.

8. The method according to claim 7 wherein a flag is periodically present in the transmitted at least one advertisement.

9. The method according to claim 1 wherein the beacon is JavaScript code associated with at least one of the at least one advertisement.

10. In a computer readable storage medium having stored therein data representing instructions executable by a programmed processor for confirming advertisement impressions, the storage medium comprising instructions for:
measuring advertisement impressions with an identifier;
recording identifier logging data regarding the measured advertisement impressions;
recording web server logging data regarding advertisement delivery; and
comparing the identifier, the identifier logging data, the web server logging data, or combinations thereof to confirm the measured advertisement impressions.

11. The storage medium according to claim 10 wherein the identifier comprises a beacon.

12. The storage medium according to claim 11 wherein the beacon comprises a pixel.

13. The storage medium according to claim 10 wherein step of comparing includes comparing the identifier logging data with the web server logging data to verify that the identifier logging data identified a comparable number of the measured advertisement impressions as were delivered over a web server according to the web server logging data.

14. The storage medium according to claim 13 wherein the web server logging data may be stored in a local file.

15. The storage medium according to claim 10 wherein the identifier is associated with at least one advertisement in a page.

16. The storage medium according to claim 15 wherein the step of comparing includes comparing the at least one advertisement with the identifier associated with the at least one advertisement.

17. A system for monitoring ad impressions, the system comprising:
a web server configured to be coupled with a network;
an ad server coupled with the web server, and
a beacon server configured to be coupled with the network, wherein the beacon server is configured to include an identifier with an advertisement, the identifier tracking the ad impressions;
wherein the ad server is configured to verify the ad impressions tracked by the identifier.

18. The system according to claim 17 further comprising:
a web server log database coupled with the web server; and
a beacon server log database coupled with the beacon server.

19. The system according to claim 18 wherein the beacon server log database includes the ad impressions tracked by the identifier and the web server log database includes the advertisements delivered by the web server.

20. The system according to claim 19 wherein the verification is a comparison between the identifier, the web server log database, the beacon server log database, the advertisement, or combinations thereof.

21. The system according to claim 20 wherein the comparison determines whether the ad impressions tracked by the identifier are equivalent to the data in the web server log database.
